(19) United States
(12) Patent Application Publication
(10) Pub. No.: US 2024/0143242 A1
(43) Pub. Date: May 2, 2024

(54) INFORMATION PROCESSING APPARATUS, SYSTEM, CONTROL METHOD FOR THE SYSTEM, AND STORAGE MEDIUM

(71) Applicant: CANON KABUSHIKI KAISHA, Tokyo (JP)

(72) Inventor: MASAKI YAMAMICHI, Kanagawa (JP)

(21) Appl. No.: 18/498,206

(22) Filed: Oct. 31, 2023

(30) Foreign Application Priority Data
Oct. 31, 2022 (JP) 2022-174111

(51) Int. Cl. G06F 3/12

(52) U.S. Cl. CPC G06F 3/1204; G06F 3/1225; G06F 3/126; G06F 3/1288

(57) ABSTRACT

An information processing apparatus on which a printer driver is installed includes one or more processors, and at least one memory in communication with the one or more processors and having stored thereon instructions, which when executed by the one or more processors, cause the information processing apparatus to function as a reception unit configured to receive printer information about a printer registered with a cloud print service from the cloud print service, an acquisition unit configured to acquire information indicating whether an extension application is present from the printer information, a display unit configured to display a printer list based on the information acquired by the acquisition unit, a selection unit configured to select a printer from the printer list, and an installation unit configured to install the printer driver and the extension application with a printer selected from the printer list.

### BACKGROUND

### Field

The present disclosure relates to an information processing apparatus, a system, a control method for the system, and a storage medium.

### Description of the Related Art

General-purpose printer drivers using industry standard protocols, such as an Internet Printing Protocol (IPP), have recently been developed. Examples of the general-purpose printer drivers include a local printer driver that is directly connected to a printer, and a cloud printer driver that transmits print data to a cloud print service.

In a cloud printer service, first, an administrator registers printers with the cloud print service. A user who will perform printing selects a printer to be used from among the printers registered with the cloud print service, thereby adding a print queue to a client terminal.

General-purpose printer drivers are able to communicate with printers provided by a plurality of printer vendors. In adding a print queue, the use of a general-purpose printer driver makes it possible to transmit print data to an image forming apparatus and a cloud print service without the need for the user to install the printer driver unique to the printer vendor.

The general-purpose printer drivers deals with print jobs to be printed by printers provided by various vendors, which limits items and functions settable as print settings. Japanese Patent Application Laid-Open No. 2021-124791 discusses a technique for extending a print queue associated with a printer driver using identification information about a printer associated with the printer driver. This makes it possible to implement a print setting user interface (UI) and a print job editing function that are unique to the vendor.

### SUMMARY

According to an aspect of the present disclosure, an information processing apparatus on which a printer driver is installed includes one or more processors, and at least one memory in communication with the one or more processors and having stored thereon instructions, which when executed by the one or more processors, cause the information processing apparatus to function as a reception unit configured to receive printer information about a printer registered with a cloud print service from the cloud print service, an acquisition unit configured to acquire information indicating whether an extension application is present from the printer information, a display unit configured to display a printer list based on the information acquired by the acquisition unit, a selection unit configured to select a printer from the printer list, and an installation unit configured to install the printer driver and the extension application with the selected printer.

Further features of the present disclosure will become apparent from the following description of exemplary embodiments with reference to the attached drawings.

### BRIEF DESCRIPTION OF THE DRAWINGS

FIG. 1 is a block diagram illustrating an example of a printing system according to a first exemplary embodiment.

FIGS. 2A to 2E are block diagrams illustrating hardware configuration examples of information processing apparatuses and an image forming apparatus according to the first exemplary embodiment.

FIGS. 3A and 3B are a sequence diagram illustrating an example of a processing sequence of registering a cloud-print-support printer with a cloud print service according to the first exemplary embodiment.

FIGS. 4A and 4B are a sequence diagram illustrating an example of a processing sequence of adding a print queue and installing a print setting extension application according to the first exemplary embodiment.

FIG. 5 illustrates an example of configuration information stored in the cloud-print-support printer according to the first exemplary embodiment.

FIG. 6A illustrates an example of device configuration information included in an operating system (OS) according to the first exemplary embodiment.

FIGS. 6B-1 and 6B-2 illustrate an example of device configuration information extended based on information acquired from the cloud print service according to the first exemplary embodiment.

FIG. 7 illustrates an example of an extended setup information file acquired from an online support service according to the first exemplary embodiment.

FIGS. 8A and 8B are a sequence diagram illustrating an example of a processing sequence of making print settings using the print setting extension application and transmitting print data according to the first exemplary embodiment.

FIGS. 9A to 9D each illustrate an example of a print setting screen to be displayed with the print setting extension application not installed in the first exemplary embodiment.

FIGS. 10A to 10E each illustrate an example of a print setting screen to be displayed with the print setting extension application installed in the first exemplary embodiment.

FIG. 11 illustrates an example of a print setting screen to be displayed by a document generation application according to the first exemplary embodiment.

FIG. 12 illustrates an example of a screen to be displayed on a client terminal according to the first exemplary embodiment.

FIG. 13 illustrates an example of a data list in which print queues held in the cloud print service and information associated with the print queues are stored according to the first exemplary embodiment.

FIGS. 14A and 14B are a flowchart illustrating processing for adding a print queue to the client terminal and installing the print setting extension application according to the first exemplary embodiment.

FIG. 15 is a flowchart illustrating processing for making print settings using the print setting extension application and generating print data according to the first exemplary embodiment.

FIGS. 16A and 16B are a flowchart illustrating processing for adding a print queue to the client terminal and installing the print setting extension application according to a second exemplary embodiment.

### DESCRIPTION OF THE EMBODIMENTS

There may be a scenario where no print setting extension application compatible with a print queue is selected by a user and is added to a client terminal. If a function intended by the user is unusable in a general-purpose printer driver, the addition of a print queue for which no print setting extension application is present does not allow use of the intended function, which makes it necessary for the user to add another print queue. The present disclosure is directed to solving the above-described issues.

A first exemplary embodiment of the present disclosure will be described below with reference to the drawings.

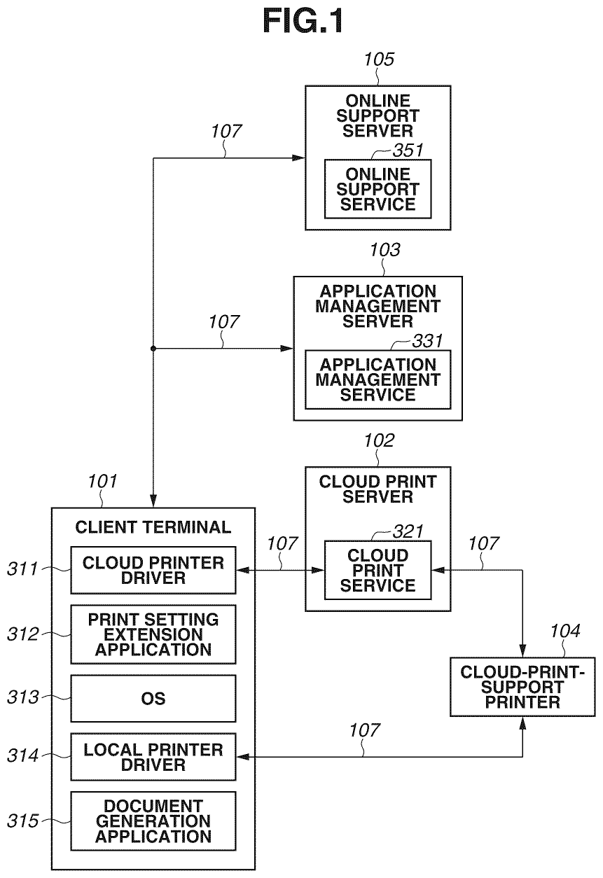

FIG. 1 is a block diagram illustrating a configuration example of a printing system for cloud printing according to the first exemplary embodiment. A client terminal 101, a cloud print server 102, an application management server 103, a cloud-print-support printer 104, and an online support server 105 are interconnected via a network 107.

While FIG. 1 illustrates one client terminal 101 and one cloud-print-support printer 104, two or more client terminals 101 and two or more cloud-print-support printers 104 may be provided.

The cloud print server 102, the application management server 103, and the online support server 105 may be a server system composed of a plurality of information processing apparatuses. The configuration in which each server is a server system composed of a plurality of information processing apparatuses allows the processing load to be distributed to the plurality of information processing apparatuses.

Physically, the cloud print server 102, the application management server 103, and the online support server 105 may be virtually formed inside one information processing apparatus.

It is premised that the network 107 establishes a connection to a cloud service through a wide area network (WAN), such as the Internet. However, all the networks 107 may be included in a closed environment, such as an intracompany local area network (LAN).

The client terminal 101 is an information processing apparatus, such as a personal computer (PC), a tablet, or a smartphone, and is a terminal directly operated by the user. Application software can be run on the client terminal 101. The client terminal 101 includes an operating system (OS) 313 and a document generation application 315 to be described below as basic software.

The cloud-print-support printer 104 is a device that actually performs printing on a recording medium, such as sheets, and is an image forming apparatus that performs printing after converting print data received via the network 107 into image data.

The cloud-print-support printer 104 can receive print data from the client terminal 101 via the cloud print server 102, and can directly receive print data from the client terminal 101 not via the cloud print server 102.

The cloud-print-support printer 104 receives print data generated by a cloud printer driver 311 in the client terminal 101 via the cloud print server 102. The cloud-print-support printer 104 receives print data generated by a local printer driver 314 in the client terminal 101 not via the cloud print server 102.

The cloud print server 102 receives printing instructions and print data from the outside. Then, the cloud print server 102 transmits the received print data to the predetermined cloud-print-support printer 104.

The application management server 103 holds and manages various applications.

The application management server 103 receives application identification information and an application download request from the client terminal 101, and transmits the application identified based on the received identification information to the client terminal 101.

The online support server 105 is a server apparatus that provides an online support service 351. The online support service 351 is a server apparatus that provides the client terminal 101 with an extended setup information file in which information for extending functions of the client terminal 101 is described.

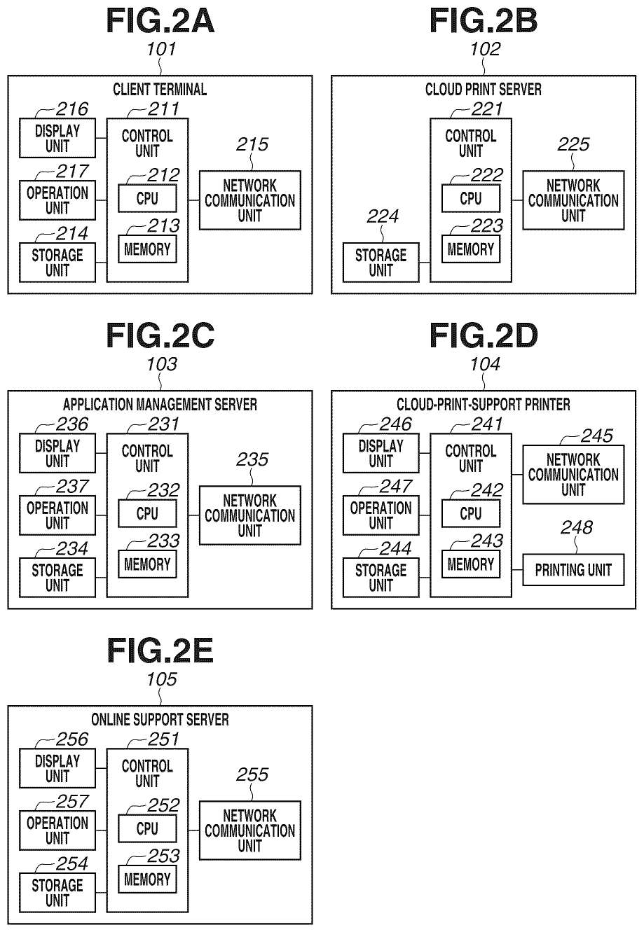

Next, a hardware configuration example of the system according to the present exemplary embodiment will be described with reference to FIGS. 2A to 2E.

FIG. 2A is a block diagram illustrating a hardware configuration example of the client terminal 101.

The client terminal 101 includes a display unit 216, an operation unit 217, a storage unit 214, a control unit 211, and a network communication unit 215.

The storage unit 214 is a nonvolatile storage device, such as a hard disk drive (HDD) or a solid-state drive (SSD), which is configured to store and rewrite digital data.

The control unit 211 is composed of a central processing unit (CPU) 212 and a memory 213, and controls the overall operation of the client terminal 101. The CPU 212 loads programs stored in the storage unit 214 into the memory 213 and runs the programs. The memory 213 is a main storage memory for the CPU 212, and is used as a temporary storage area for loading various programs.

The network communication unit 215 is a device that communicates with the external network 107, and inputs and outputs digital data to and from an external server, the client terminal 101, and the like via the network 107.

The display unit 216 is a device that displays visual information for the user. The display unit 216 is, for example, a liquid crystal display. The operation unit 217 is a device that receives inputs from the user via a keyboard, a mouse, or the like. A device including both functions of the display unit 216 and the operation unit 217, such as a touch panel, may also be used.

FIG. 2B is a block diagram illustrating a hardware configuration example of the cloud print server 102. The cloud print server 102 includes a storage unit 224, a control unit 221, and a network communication unit 225.

The storage unit 224, the control unit 221, and the network communication unit 225 are equivalent to those of the client terminal 101, and thus the descriptions thereof are omitted.

In the present exemplary embodiment, the cloud print server 102 is composed of one information processing apparatus having the hardware configuration illustrated in FIG. 2B, but instead may be composed of a plurality of information processing apparatuses having the hardware configuration illustrated in FIG. 2B.

FIG. 2C is a block diagram illustrating a hardware configuration example of the application management server 103. The application management server 103 includes a display unit 236, an operation unit 237, a storage unit 234, a control unit 231, and a network communication unit 235.

The display unit 236, the operation unit 237, the storage unit 234, the control unit 231, and the network communication unit 235 are equivalent to those of the client terminal 101, and thus the descriptions thereof are omitted.

In the present exemplary embodiment, the application management server 103 is composed of one information processing apparatus having the hardware configuration illustrated in FIG. 2C, but instead may be composed of a plurality of information processing apparatuses.

FIG. 2D is a block diagram illustrating a hardware configuration example of the cloud-print-support printer 104. The cloud-print-support printer 104 includes a display unit 246, an operation unit 247, a storage unit 244, a control unit 241, a network communication unit 245, and a printing unit 248.

The display unit 246 is a device that displays information for the user. The display unit 246 is, for example, a touch panel or light-emitting diodes (LED) that is or are attached to the cloud-print-support printer 104.

The operation unit 247 is a device that receives inputs from the user, and may include, in addition to a touch panel, hardware keys, such as a numeric keypad. The storage unit 244 and the control unit 241 are equivalent to those of the client terminal 101, and thus the descriptions thereof are omitted.

The network communication unit 245 is a device that communicates with the external network 107, and mainly functions to receive print data and transmit information indicating the state of the cloud-print-support printer 104, such as an error state, to the external server or the like.

The printing unit 248 is a device that performs printing processing by performing a series of operations of sheet feeding, printing, and sheet discharge on sheets prepared in a cassette or a tray. The printing method is not particularly limited. For example, an electrophotographic method and an inkjet method may be used. The printing unit 248 includes a double-sided printing unit used during sheet discharge, and a finishing device that performs stapling, punching, and other processes.

In the present exemplary embodiment, a single-function printer the implements only a print function is used as an example of the cloud-print-support printer 104. Alternatively, a multi-function printer (multifunction peripheral) having a scanner function and a facsimile (FAX) function may be used.

FIG. 2E is a block diagram illustrating a detailed hardware configuration example of the online support server 105. In the present exemplary embodiment, the online support server 105 is composed of one information processing apparatus, but instead may be composed of a plurality of information processing apparatuses. The online support server 105 includes a display unit 256, an operation unit 257, a storage unit 254, a control unit 251, and a network communication unit 255. The display unit 256 and the operation unit 257 are similar to the display unit 216 and the operation unit 217, respectively, in the client terminal 101, and thus the descriptions thereof are omitted. The storage unit 254 is a memory device, such as an HDD or SSD. The storage unit 254 stores an extended setup information file in which information for extending functions provided by the client terminal 101 is described.

The control unit 251 is composed of a CPU 252 and a memory 253. The CPU 252 controls the overall operation of the online support server 105. The memory 253 is used for processing to be performed by the CPU 252. The network communication unit 255 is an interface for the online support server 105 to communicate with the client terminal 101. The online support server 105 receives a request for acquiring a file stored in the storage unit 254 via the network communication unit 255, and transmits the corresponding file to the client terminal 101.

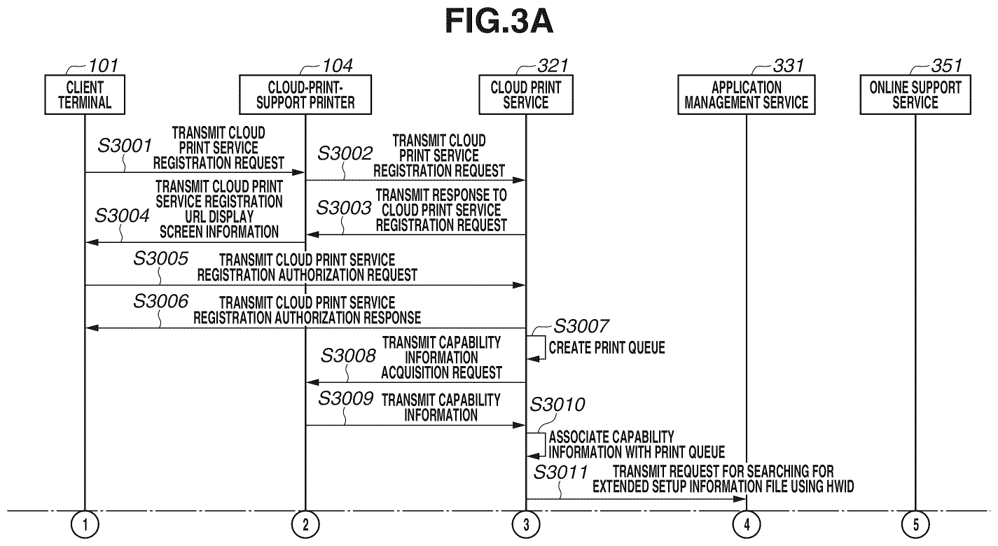

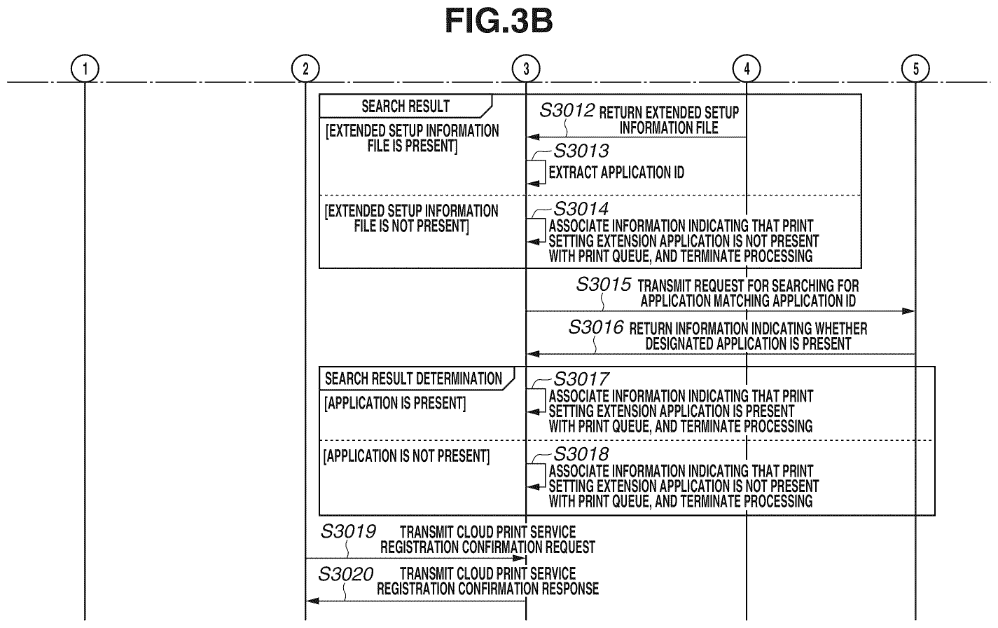

Next, an example of a user's processing procedure for registering a printer with a cloud print service according to the present exemplary embodiment and an example of a processing sequence between each piece of software and the print service will be described with reference to FIGS. 3A and 3B. In this case, the user and the client terminal may be the same as or different from the user and the client terminal that add a print queue to the client terminal 101 and perform printing as described below.

In step S3001, the user first transmits a cloud print service registration request to the cloud-print-support printer 104 via a web user interface (UI) using a web UI client of the client terminal 101. Upon receiving the request, in step S3002, the cloud-print-support printer 104 transmits the cloud print service registration request together with device identification information about the printer to the cloud print service 321. The device identification information transmitted to the cloud print service 321 is, for example, a hardware identification (HWID) to be allocated to each printer model. Any information may be used as the device identification information, as long as the information can be used to identify each printer model.

Upon receiving the request, in step S3003, the cloud print service 321 transmits a cloud print service registration request response including a registration uniform resource locator (URL) for cloud print registration to the cloud-print-support printer 104. Upon receiving the response, in step S3004, the cloud-print-support printer 104 transmits registration URL display screen information including a cloud print service registration URL to the client terminal 101 via the web UI.

Upon receiving the screen information, the client terminal 101 displays the registration URL on the web UI client. The user operates the web UI client of the client terminal 101 and inputs a user identifier (ID) and a password for using the cloud print service 321 to log into the cloud print service 321. If the user login is successful, in step S3005, the client terminal 101 transmits a cloud print service registration authorization request to the cloud print service 321.

Upon receiving the registration authorization request, in step S3006, the cloud print service 321 transmits a cloud print service registration authorization response to the client terminal 101. Upon receiving the registration authorization request, in step S3007, the cloud print service 321 registers information (printer name, Internet Protocol (IP) address, etc.) about the cloud printer 104 and creates a print queue for the cloud-print-support printer 104. In this case, the cloud print service 321 may acquire the information about the cloud-print-support printer 104 from the cloud-print-support printer 104 in creation of this print queue, or may transmit the information together with device identification information from the cloud-print-support printer 104 in issuance of the cloud print service registration request in step S3002.

After the print queue is created, in step S3008, the cloud print service 321 transmits a capability information acquisition request to the cloud-print-support printer 104. Upon receiving the capability information acquisition request, in step S3009, the cloud-print-support printer 104 transmits capability information to the cloud print service 321. In step S3010, the cloud print service 321 that has acquired the capability information associates the capability information with the created print queue. The capability information is information indicating the functions of the printer, and refers to information to be used for the user to make print settings in printing, such as information indicating that double-sided printing can be performed, information indicating that color printing can be performed, or information indicating that stapling can be performed.

Next, the cloud print service 321 performs processing for associating information indicating whether an extension application is present to the printer registered with the print queue. First, the cloud print service 321 performs identification additional information attachment processing on the device identification information. This processing is desirably performed to acquire an extended setup information file 700 for the online support server 105 using a character string different from the general device identification information. In the present exemplary embodiment, identification additional information (“PrinterApp_”) indicating the application supported by the printer is attached to the device identification information so as to distinguish the application from among applications of other devices. “PrinterApp_” is merely an example, and any other character strings, numbers, and signs may be used. As a result of the processing described above, for example, if the device identification information about the cloud-print-support printer 104 indicates “device001”, device identification information obtained after the identification additional information attachment processing indicates “PrinterApp_devoce001”.

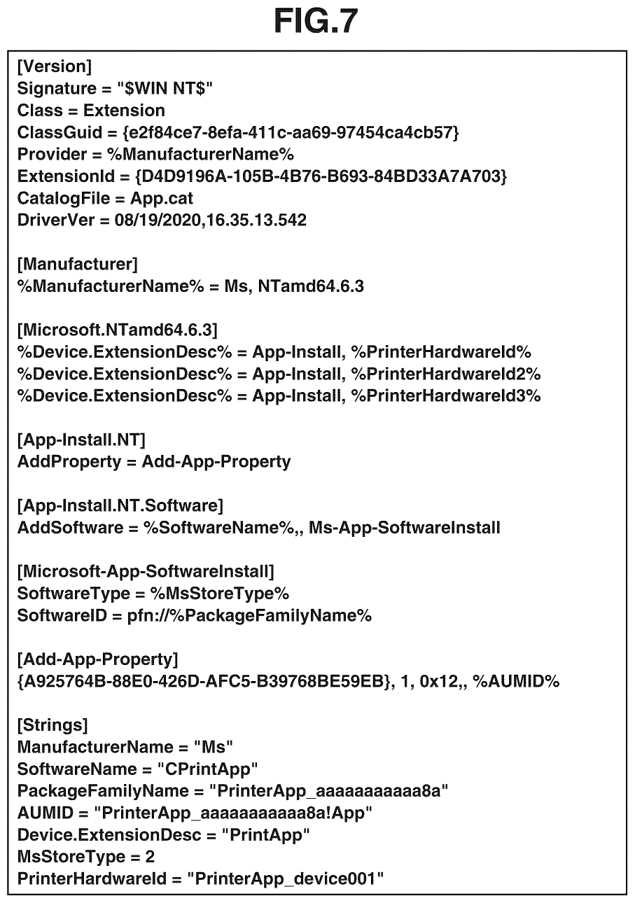

In step S3011, the cloud print service 321 transmits a request for searching the extended setup information file 700 including the device identification information with target additional information to the online support service 351. In step S3011, a notification indicating “PrinterApp_device001” to which the identification additional information is attached is issued to the online support service 351. An extended setup information file illustrated in FIG. 7 is stored in the online support service 351. FIG. 7 illustrates an example of the extended setup information file 700. The extended setup information file is a file that is created by a vendor that provides the cloud-print-support printer 104 and is registered with the online support service 351.

In the extended setup information file 700, an application identifier for identifying a print setting extension application used to set print data to be transmitted to the cloud-print-support printer 104 is described. In the extended setup information file 700 illustrated in FIG. 7, the item “PackageFamilyName” indicates extension application identification information. As “PrinterHardwareID”, a character string obtained by attaching identification additional information to the identification information about the cloud-print-support printer 104 is described.

The online support service 351 stores, in addition to the extended setup information file in which the extension application identification information is described, the extended setup information in which printer driver identification information is described. In the extended setup information file in which the printer driver identifier is described, the printer driver identifier is described in “PackageFamilyName”. As “PrinterHardwareId” in the extended setup information file, device identification information including no identification additional information is described.

As described above, the online support service 351 stores both the extended setup information file in which the printer driver identifier is described and the extended setup information file in which the print setting application identifier is described. Thus, identification additional information is added to the device identification information to acquire the required extended setup information file as appropriate.

The online support service 351 that has received a search request identifies the extended setup information file in which the device identification information including the identification additional information designated in the request matches “PackageFamilyName” in the file.

As a result of the search, if the online support service 351 stores the extended setup information file 700 including the target device identification information, in step S3012, the online support service 351 returns the extended setup information file 700 to the cloud print service 321.

Next, in step S3013, the cloud print service 321 extracts an application ID from the extended setup information. The application ID refers to an identifier specified by “PackageFamilyName” in the extended setup information file.

The above-described processing is performed when the online support service 351 stores the extended setup file corresponding to the cloud-print-support printer 104.

As a result of the search, the online support service 351 cannot detect the extended setup information file 700 including the target device identification information in some cases. In this case, in step S3014, the cloud print service 321 associates information indicating that the print setting extension application is not present with the print queue for the cloud-print-support printer 104. If the extended setup file cannot be received within a predetermined period from the search request in step S3013, or if an error notification is received from the online support service 351, the cloud print service 321 performs the processing in step S3014. In the above-described exemplary embodiment, the processing of searching the extended setup file is performed by adding a predetermined character string to the device identification information about the cloud-print-support printer 104. This search processing may be performed without adding the predetermined character string, as long as the extended setup file can be searched using only the HWID of the printer.

Processing to be performed if the extended setup file can be acquired in steps S3015 to S3018 and the application ID can be extracted in step S3013 will be described.

In step S3015, the cloud print service 321 transmits a request for searching an application matching the extracted application ID to the application management service 331. The application management service 331 stores an application to run on the client terminal 101 and an application ID as an identifier for the application in an associated manner. The application and the application ID are registered with the application management service 331 by the vendor that provides the cloud-print-support printer 104.

If the application management service 331 holds the print setting extension application matching the requested application ID, the application management service 331 returns a response indicating that a print setting extension application 312 is present to the cloud print service 321. If the application management service 331 does not holds the print setting extension application, in step S3016, the application management service 331 returns the response indicating that the print setting extension application 312 is not present. In this case, if the application management service 331 holds the print setting extension application, the application management service 331 may return the print setting extension application itself. In step S3017, the cloud print service 321 that has received information indicating that the print setting extension application 312 is present associates information indicating that the print setting extension application is present with the print queue for the cloud-print-support printer 104. In step S3018, the cloud print service 321 that has received information indicating that the print setting extension application 312 is not present associates information indicating that the print setting extension application is not present with the print queue for the cloud-print-support printer 104. When the above-described processing is completed, the printer registration processing in the cloud print service 321 is completed.

The cloud-print-support printer 104 performs processing for determining whether the processing of steps S3007 to S3018 is completed and the printer is registered with the cloud print service 321. In step S3019, the cloud-print-support printer 104 transmits a cloud print service registration confirmation request to the cloud print service 321. The processing of step S3019 is performed by periodically transmitting a request to the cloud print service 321 (polling). Alternatively, some event may be received from the cloud print service 321.

Upon receiving the registration confirmation request, in step S3020, the cloud print service 321 transmits a cloud print service registration confirmation response including a cloud printer ID to the cloud-print-support printer 104.

At this stage, the cloud-print-support printer 104 is registered with the cloud print service 321 and is ready for using the cloud print service.

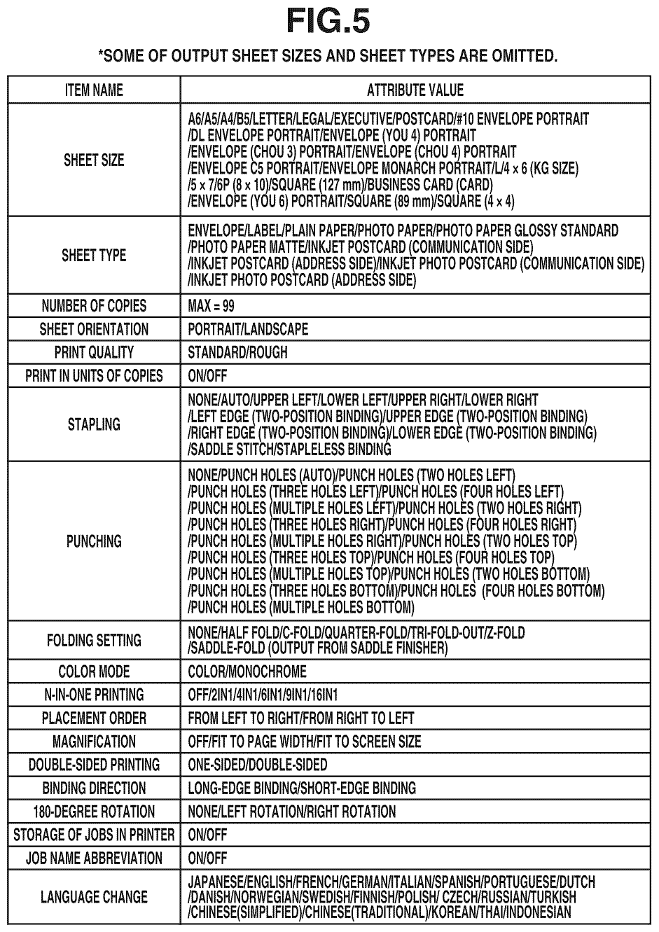

FIG. 5 illustrates an example of capability information. The capability information is composed of item names and attribute values. The item names correspond to setting items for print settings. The attribute values correspond to setting values, options, and ranges that can be set in each setting item. The cloud-print-support printer 104 stores, in addition to the item names and attribute values defined as industry-standard specifications by an Internet Printing Protocol (IPP), item names and attribute values uniquely defined by the printer vendor.

For example, “storage of jobs in printer”, “job name abbreviation”, and “stapleless binding” among the item names illustrated in FIG. 5 and attribute values associated with these items are item names and attribute values that are uniquely defined by the printer vendor. The setting item “storage of jobs in printer” is used for the printer to set whether to store the print data received from the cloud print service 321 in the printer even after printing is performed.

The setting item “job name abbreviation” is used to set whether to display an abbreviated name attached to the print data when the printer displays bibliography information about the print data received from the cloud print service 321 on the display unit of the printer. The setting item “stapleless binding” is used to set whether to bind output sheets based on the print data received by the printer from the cloud print service 321 without using staples. The stapleless binding refers to binding of sheets, for example, by crimping.

Attribute values unique to the printer vendor may be defined as the attribute values corresponding to the item names defined as the industry-standard specifications. For example, the item name “folding setting” is defined by the IPP. As one of the attribute values for “folding setting”, “saddle-fold” is a function of folding and discharging all sheets at once without stapling one or more sheets and is an attribute value uniquely defined by the printer vendor.

In the present exemplary embodiment, capability information is transmitted to the cloud print service 321 in accordance with the IPP as a communication protocol. The cloud-print-support printer 104 registers the capability information using a command prepared for the cloud-print-support printer 104 to register the capability information with the cloud print service 321. The cloud-print-support printer 104 issues a notification about the item names illustrated in FIG. 5 and the attribute values and default values corresponding to each item name to the cloud print service 321. In this case, the notification about the capability information is issued regardless of whether the items and attribute values are defined by the IPP.

For example, a notification indicating the item names “storage of jobs in printer” and “job name abbreviation” and the attribute value “stapleless binding” illustrated in FIG. 5 is also issued to the cloud print service 321. The attribute value “saddle-fold” that is one of the attribute values for “folding setting” and is uniquely defined by the printer vendor is also registered as one of the attribute values for “folding setting” with the cloud print service 321.

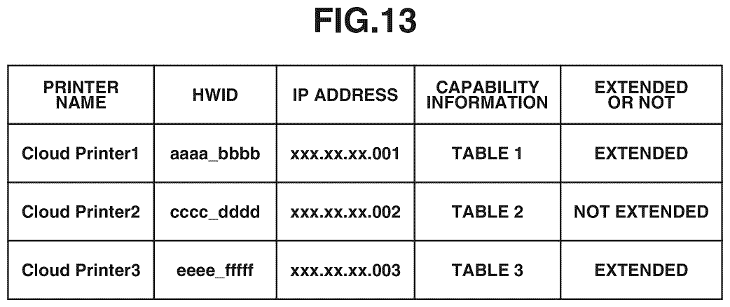

FIG. 13 illustrates an example of a data list in which print queues held in the cloud print service 321 and information associated with the print queues are stored. The item “printer name” refers to a printer name acquired from the cloud-print-support printer 104 in registration. The item “HWID” refers to an identifier (identifier unique to each model) used to identify the model of the cloud-print-support printer 104. The item “IP address” refers to the IP address of the connected printer. The item “capability information” refers to a table including the item names and attribute values illustrated in FIG. 5, and the table is held in association with each print queue. The item “extended or not” indicates the result of processing illustrated in FIGS. 3A and 3B, and information indicating whether the print setting extension application 312 that is compatible with a print queue for the printer is present is registered.

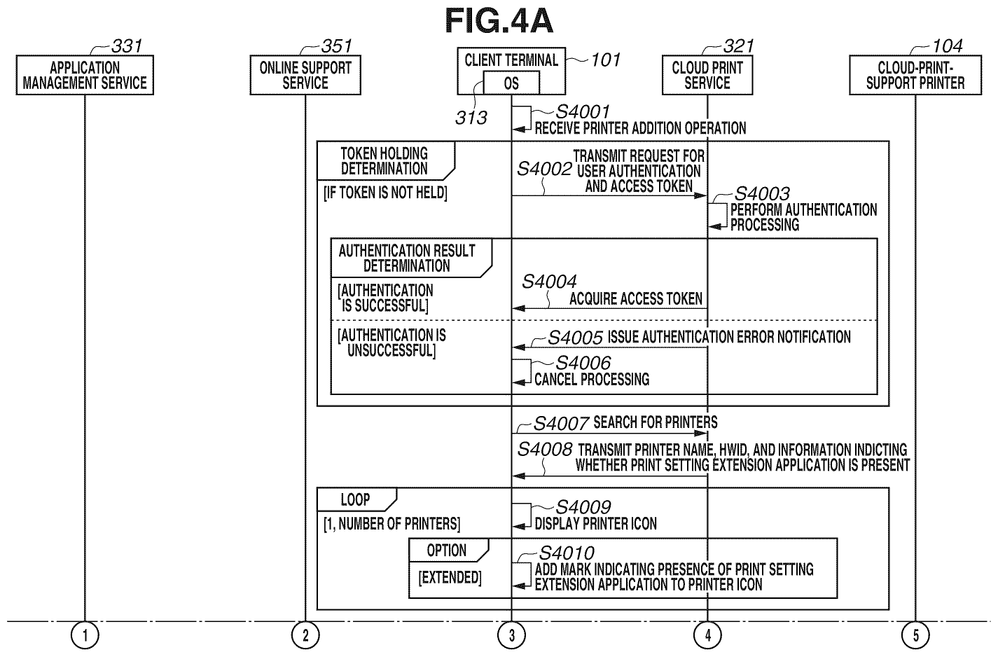

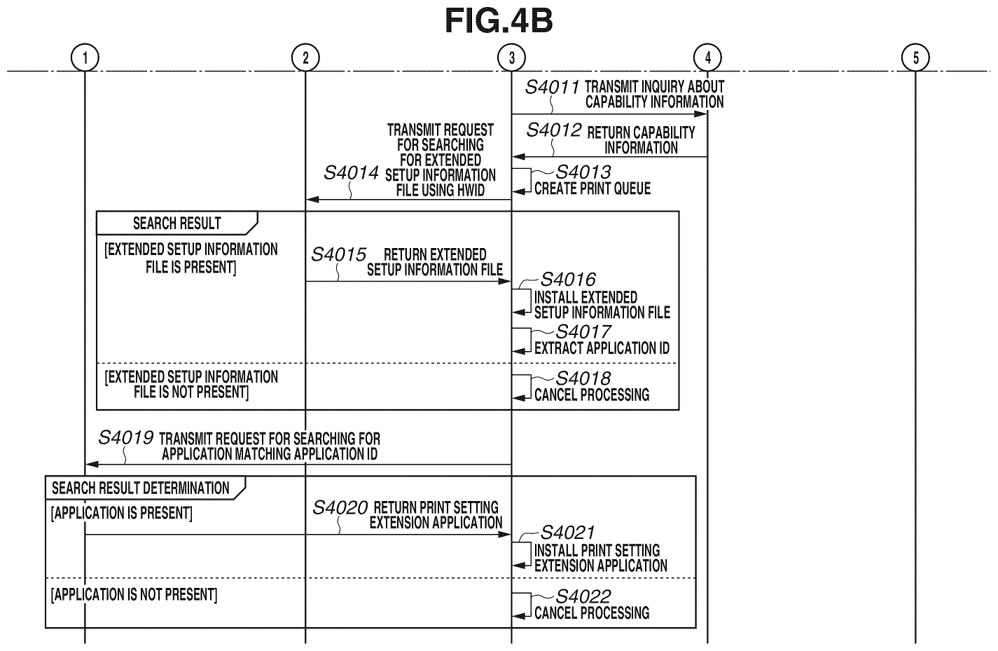

Next, processing of adding a print queue to the client terminal 101 and installing the print setting extension application 312 when the user performs a setup operation on the client terminal 101 to perform printing on the cloud-print-support printer 104 will be described with reference to FIGS. 4A and 4B. In the case of registering the cloud-print-support printer 104 with the client terminal 101, the standard print function that is one of the functions of the OS 313 of the client terminal 101 is used.

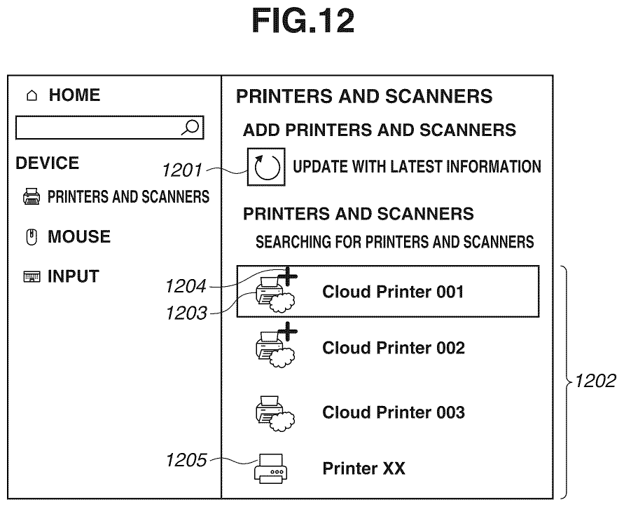

In step S4001, the OS 313 of the client terminal 101 receives a printer addition operation as a setup operation for the cloud-print-support printer 104 performed by the user. As the setup operation for the cloud-print-support printer 104, for example, the following operation is performed. FIG. 12 illustrates an example of a screen for the printer registered with the client terminal 101 that is displayed by the OS 313 of the client terminal 101. The user selects an object 1201, thereby inputting a printer search instruction to the OS 313.

The OS 313 that has received the printer search instruction determines whether a token for the cloud print service 321 is held in the OS 313. If the OS 313 does not hold the token, the OS 313 displays a screen for inputting user information (login name, password) (not illustrated). In step S4002, the OS 313 of the client terminal 101 transmits user information input via the screen to the cloud print service 321 and transmits a request for user authentication and access token.

In step S4003, the cloud print service 321 performs authentication processing using the user information received from the client terminal 101. Upon completion of the authentication processing, the cloud print service 321 issues a notification about the authentication processing result to the client terminal 101.

If the user authentication is successful, in step S4004, the OS 313 of the client terminal 101 acquires the access token from the cloud print service 321. If the user authentication is unsuccessful in step S4003, in step S4005, the cloud print service 321 issues a notification about an authentication error to the OS 313 of the client terminal 101. In step S4006, the OS 313 of the client terminal 101 cancels the processing based on the received information about the authentication error. If the access token cannot be acquired, the OS 313 of the client terminal 101 terminates the processing illustrated in FIGS. 4A and 4B.

If the OS 313 of the client terminal 101 holds the access token, or if the OS 313 of the client terminal 101 has acquired the access token in step S4004, the processing proceeds to step S4007. The OS 313 searches for printers registered in the cloud print service 321 and printers connected to the network 107.

In step S4007, the OS 313 of the client terminal 101 transmits a request for acquiring printer information registered with the cloud print service 321, and searches for printers. In step S4007, the OS 313 of the client terminal 101 transmits the printer information acquisition request with the access token to the cloud print service 321.

In step S4008, the cloud print service 321 transmits information about the printer that is authorized to be used by the user identified by the access token attached to the acquisition request to the client terminal 101. The printer information transmitted to the client terminal 101 in step S4008 includes the printer name given to each printer registered with the cloud print service 321, the HWID of the printer, and information indicating whether the print setting extension application 312 is present to the model of the printer.

In parallel with the processing of steps S4007 and S4008, the OS 313 of the client terminal 101 searches for printers connected to the same network as that of the client terminal 101. This is a device search by multicast domain name system (mDNS), Bonjour, or the like.

The OS 313 displays a printer list on the client terminal 101 based on the printer information acquired from the cloud print service 321 and the printer information detected in the search of the network 107. First, in step S4009, the OS 313 displays a printer icon based on the printer information acquired from the cloud print service 321. Then, if it is determined that the print setting extension application 312 is present to the model of the printer based on the information indicating whether the print setting extension application 312 is present to the model of the printer in the printer information, in step S4010, a mark indicating that the print setting extension application 312 is present is added to the printer icon.

In the processing of steps S4009 and S4010 described above, the printer information received from the cloud print service 321 is displayed as a printer list on an area 1202 illustrated in FIG. 12. In the information displayed on the area 1202, “Cloud Printer 001/002/003” is printer information registered with the cloud print service 321. On the other hand, “Printer XX” indicates a printer detected after the client terminal 101 has searched for printers on the network 107. Thus, the printer information acquired from the cloud print service 321 and the printer information detected after searching the network 107 for printers are displayed in a printer list. An icon 1203 is added to the printer information received from the cloud print service 321, and the printer information with the icon 1203 is displayed. Further, an icon 1204 indicating that the print setting extension application 312 is present is displayed for “Cloud Printer 001/002”.

An icon 1205 is added to printer information detected after searching the network 107 for printers and is displayed. This configuration makes it possible to display the printer information such that the printer information received from the cloud print service 321 can be distinguished from the printer information detected after searching the network 107 for printers, and to display the printers such that printers in which the print setting extension application 312 is present can be distinguished from printers in which the print setting extension application 312 is not present. The client terminal 101 may display only the printer information registered with the cloud print service 321.

Next, the user selects printer information corresponding to the printer to be registered with the client terminal 101 from the printer information displayed on the area 1202. In this case, the user selects the printer indicated by the icon 1205, thereby making it possible to add the printer in which the print setting extension application 312 is present to the client terminal 101.

In step S4011, the OS 313 of the client terminal 101 transmits an inquiry about capability information about the printer corresponding to the selected printer information to the cloud print service 321. The capability information on the setting items about which the OS 313 of the client terminal 101 inquires is defined in the specifications of the OS 313 and is set in the OS 313. The OS 313 of the client terminal 101 designates the setting items stored in advance and inquires about the capability information. The items preliminarily set in the OS 313 are setting items defined as standard specifications by the IPP. Examples of the items include “sheet size”, “sheet type”, and “color mode”.

In step S4012, the cloud print service 321 returns capability information about the cloud-print-support printer 104 as a response to the OS 313 of the client terminal 101.

The present exemplary embodiment is described on the premise that the information registered with the cloud print service 321 in registration in step S3001 is transmitted to the client terminal 101 in step S4012. However, the capability information registered with the cloud print service 321 may be transmitted to the client terminal 101 at any timing other than the above-described timing. For example, the capability information registered with the cloud print service 321 may be transmitted to the client terminal 101 according to the change of the capability information about the cloud-print-support printer 104. The user may issue an instruction to update the capability information on a UI provided by the cloud print service 321 and may transmit the capability information updated according to the instruction to the client terminal 101. Further, at the timing of step S4011, the cloud print service 321 may acquire capability information from the cloud-print-support printer 104, and may issue a notification about the acquired capability information to the client terminal 101.

In step S4012, the cloud print service 321 returns the attribute values and default values corresponding to the setting item designated from the client terminal 101. In this case, all attribute values registered with the cloud print service 321 are returned, regardless of whether the attribute values are defined as standard values. The default values are values initially set when the client terminal 101 displays a print setting screen. If the response to the attribute inquired about by the OS 313 of the client terminal 101 is not stored, the cloud print service 321 does not send any response to the OS 313.

Next, the OS 313 starts to install the cloud printer driver 311 based on the device identification information and printer name of the printer selected by the user. In step S4013, the OS 313 creates a print queue for the cloud printer driver 311 including basic device capability information included in the OS 313. The device capability information refers to definition information for generating the print setting capability information about the printer driver, and is, for example, information described by an extended markup language (XML), such as “PrintDeviceCapabilities”.

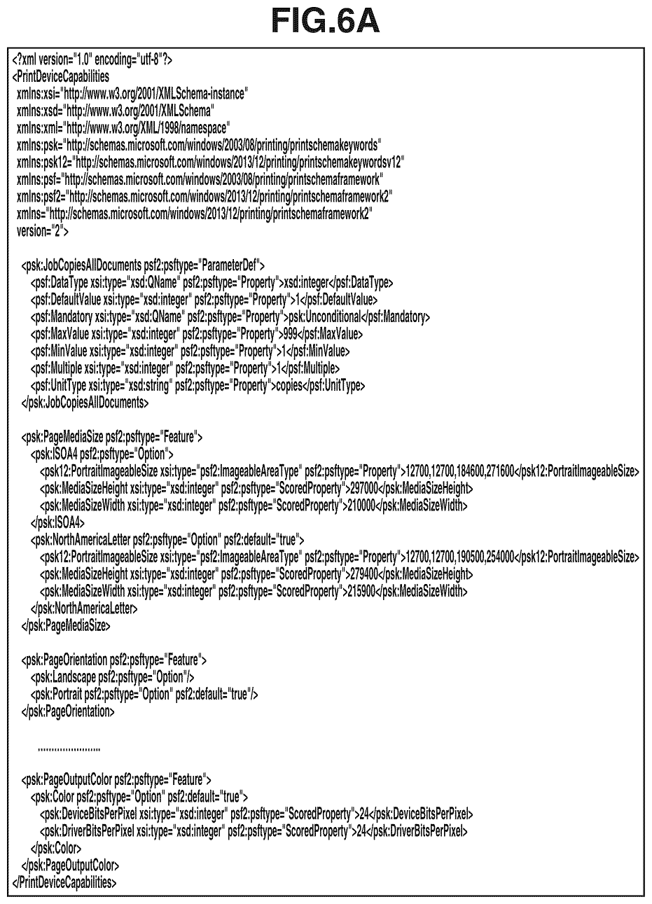

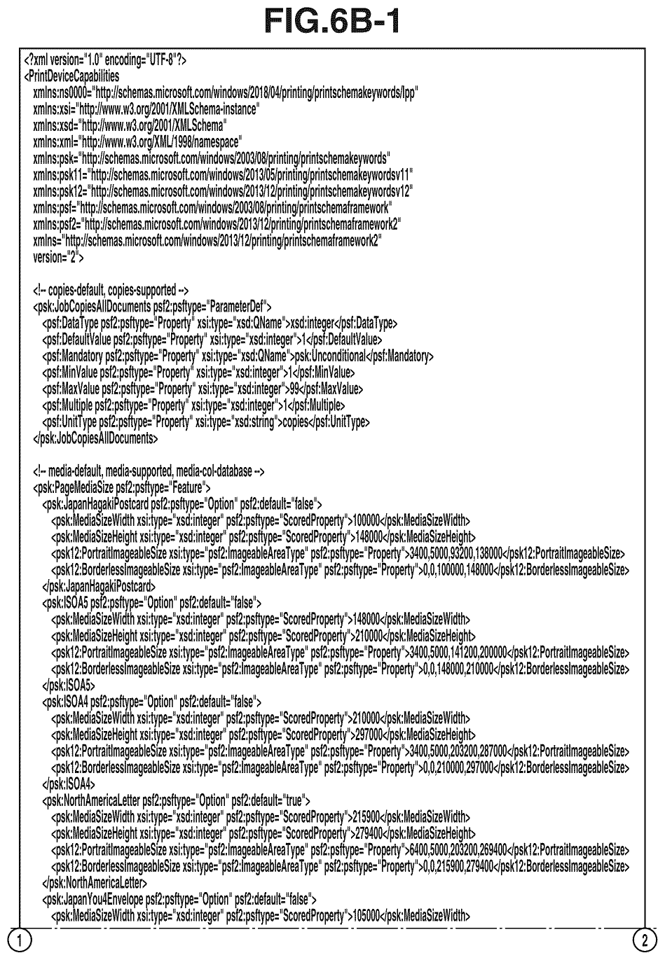

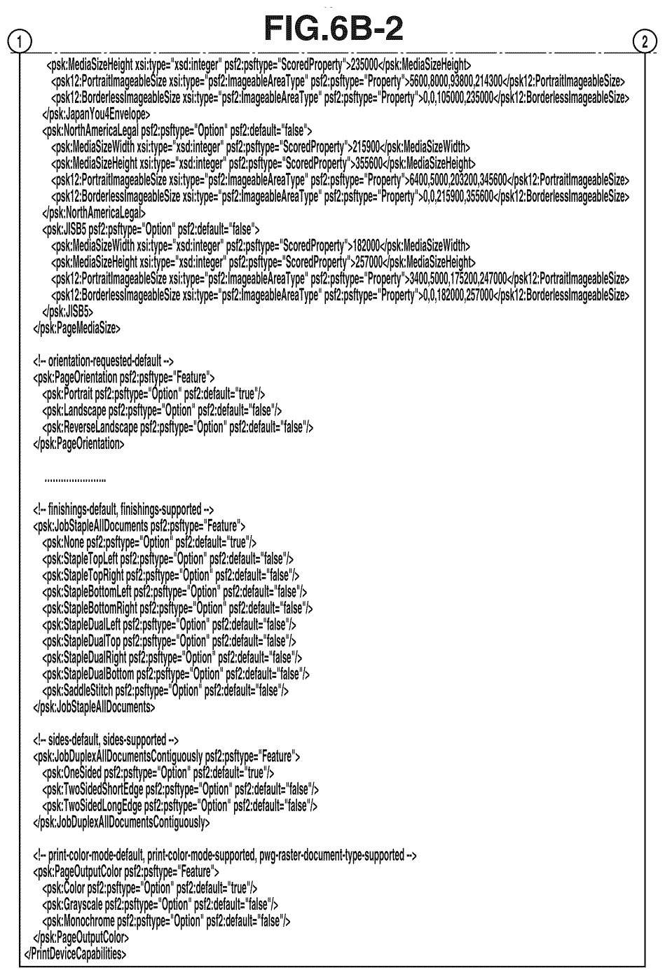

FIG. 6A illustrates an example of default device capability information included in the OS 313.

For example, “Feature” indicates that “PageMediaSize” representing a sheet size is a setting item, and “Option” indicates an option for “PageMediaSize”. In the initial value of the device capability information, as illustrated in FIG. 6A, there are only two options for the sheet size, i.e., “A4” and “Letter”. This information is stored in association with a print queue in creation of the print queue, and is managed by the OS 313. The default device capability information is fixed device capability information regardless of information about the connected printer.

After that, the OS 313 updates the device capability information constituting the cloud printer driver 311 using the capability information acquired from the cloud print service 321. FIGS. 6B-1 and 6B-2 illustrate an example of device capability information updated using the capability information acquired from the cloud print service 321. For example, “Option” other than “A4” and “Letter” is added as options for the sizes of sheets that can be printed by the cloud-print-support printer 104 are added to “PageMediaSize” representing the sheet size.

As described above, the client terminal 101 first registers the cloud printer driver 311 and the device capability information included in the OS 313 in association with a print queue. After that, the device capability information associated with the print queue is updated with the capability information acquired from the cloud print service 321. In this case, the OS 313 updates the device capability information using only the attribute values defined as the industry-standard specifications in the capability information acquired from the cloud print service 321. Thus, for example, even when attribute values unique to the vendor are acquired as the sheet type in the acquisition of the capability information, the attribute values unique to the vendor are not added to the device capability information. This configuration makes it possible to set print setting values that cannot be set in the device capability information included in the OS 313.

As described above, the installation of the cloud printer driver 311 is completed. The above-described processing makes it possible to transmit print data to the print queue for the cloud-print-support printer 104 created in the cloud print service 321 from the client terminal 101.

Next, the OS 313 starts processing of installing an application for extending the cloud printer driver 311 associated with the printer. First, the OS 313 performs processing of attaching identification additional information indicating the application compatible with the printer on the device identification information, like in step S3011. Suppose herein that “PrinterApp_devoce001” is generated as identification information, like in step S3011.

In step S4014, the OS 313 transmits a request for searching for the extended setup information file 700 including the device identification information with target additional information to the online support service 351. In step S4014, a notification about “PrinterApp_devoce001” to which the identification additional information is attached is issued to the online support service 351.

The online support service 351 that has received a search request identifies the device identification information to which the identification additional information designated in the request is attached and the extended setup information file matching “PackageFamilyName” in the file.

As a result of the search, if the online support service 351 stores the extended setup information file 700 including the target device identification information, in step S4015, the online support service 351 returns the extended setup information file 700 to the OS 313. In this case, the content of the extended setup information file 700 is written into a registry of the OS 313.

Next, in step S4016, the OS 313 installs the extended setup information written into the extended setup information file acquired from the online support service 351 in a state where the extended setup information is associated with the print queue created in step S3012.

Next, in step S4017, the OS 313 extracts an application ID from the installed extended setup information. The above-descried processing is processing to be performed when the extended setup file corresponding to the cloud-print-support printer 104 is stored in the online support service 351.

As a result of the search, the online support service 351 cannot detect the extended setup information file 700 including the target device identification information in some cases. In this case, in step S4018, the OS 313 completes the installation of the cloud printer driver 311, and cancels the application installation processing. If the extended setup file cannot be received within a predetermined period from the search request in step S4014, or if an error notification is received from the online support service 351, the OS 313 performs the processing in step S4018. Processing to be performed in step S4019 and subsequent steps is processing to be performed if the extended setup file is acquired and the application ID is extracted in step S4017. In step S4019, the OS 313 transmits a request for searching for the application matching the extracted application ID to the application management service 331.

If the application management service 331 holds the print setting extension application 312 matching the requested application ID, in step S4020, the application management service 331 returns the print setting extension application 312 to the client terminal 101.

In step S4021, the OS 313 installs the acquired print setting extension application 312 in association with the print queue on the client terminal 101. The OS 313 stores the application ID in a registry as information about the print queue. Further, the print setting extension application 312 makes a setting for the OS 313 to transmit an event notification at the timing when the print queue associated with the application is set on the print setting screen for the OS 313. The installed print setting extension application 312 is started when the client terminal 101 is powered on and the OS 313 is started. After the start-up, the print setting extension application 312 operates as a background task.

If the application management service 331 does not hold the print setting extension application 312 matching the requested application ID, in step S4022, the OS 313 cancels the application installation processing. In this case, the created print queue and the cloud printer driver 311 are installed in association with each other, and then the print setting extension application 312 terminates the processing without being associated with the print queue.

In the above-described exemplary embodiment, the processing of searching for the extended setup file is performed by adding the predetermined character string to the device identification information about the cloud-print-support printer 104. If a file for installing a printer driver is distinguishable, the search processing may be performed without adding the predetermined character string.

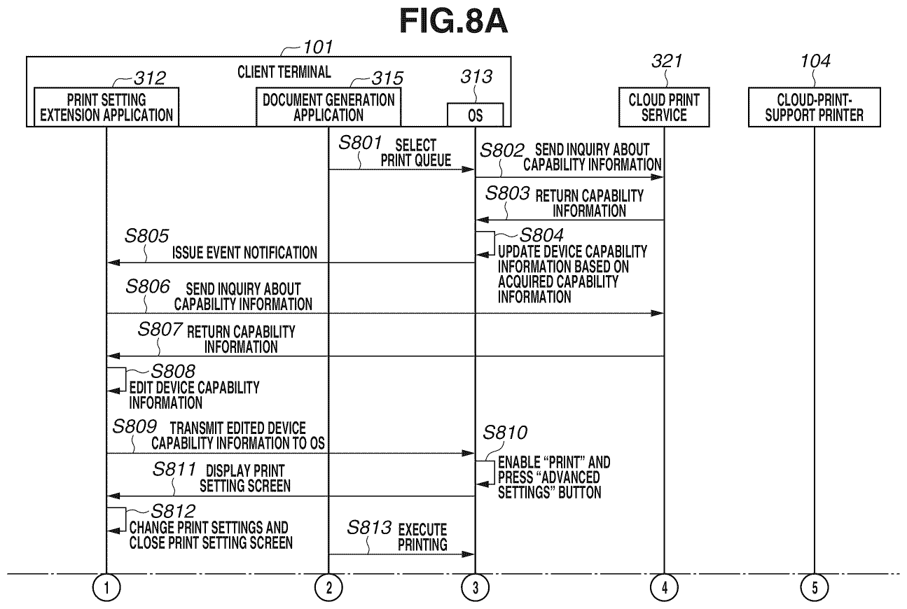

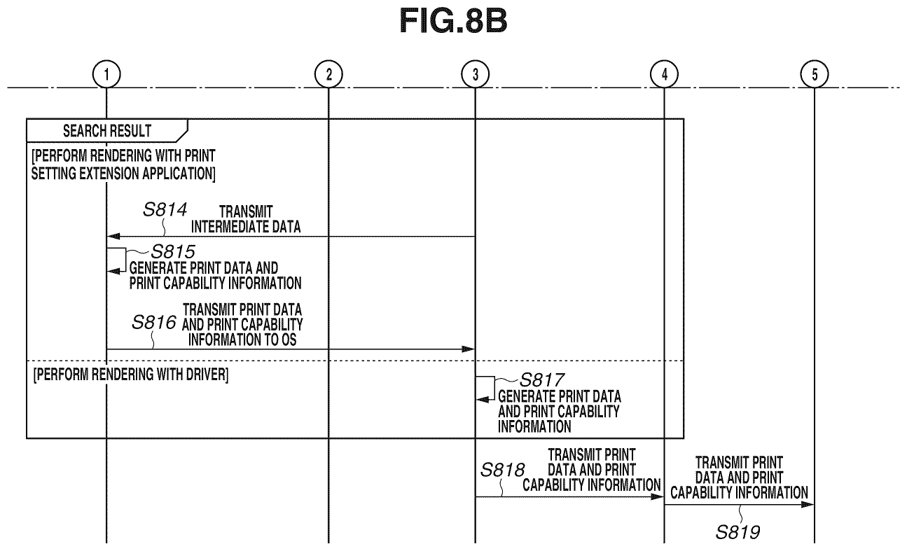

Next, an example of a user's processing procedure in printing according to the present exemplary embodiment and an example of a processing sequence between each piece of software and the print service will be described with reference to FIGS. 8A and 8B. The document generation application 315 is, for example, an application for creating document data, an application for creating presentation material, or an application for displaying photographs and image data.

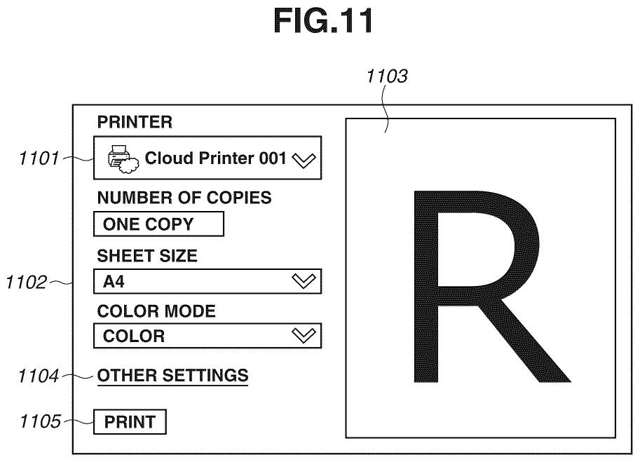

The document generation application 315 displays a print setting screen (FIG. 11) on which a print queue is selected as a print setting initial screen. In the present exemplary embodiment, the document generation application 315 displays the print setting initial screen, but instead the OS 313 may display the print setting initial screen. An object 1101 for selecting a print queue, an object 1102 for making various print settings, and a print preview image 1103 are displayed on the print setting initial screen.

In step S801, the OS 313 selects a print queue associated with a printer set as a default printer. In the present exemplary embodiment, it is premised that the cloud-print-support printer 104 is selected as the default printer. The processing of step S801 and subsequent steps is performed also when the user changes the printer to be used by operating the object 1101.

Next, in step S802, the OS 313 transmits an inquiry about capability information about the cloud-print-support printer 104 for the queue on the cloud print service 321 corresponding to the cloud-print-support printer 104. The capability information on the setting items about which the OS 313 inquires is preliminarily defined in the specifications of the OS 313. Thus, the capability information acquired at this timing is similar to that acquired in step S3001 illustrated in FIG. 3A. This inquiry is issued to the cloud-print-support printer 104 using commands of standard protocols defined by the IPP, such as “Get-print-Attributes”. In the case of using “Get-print-Attributes”, the inquiry about the capability information determined by the OS 313 is issued in a list format.

In step S803, the cloud print service 321 returns the capability information about the cloud-print-support printer 104 in the list of capability information transmitted by “Get-print-Attributes” to the OS 313. For example, attributes for the media size are designated by “Get-print-Attributes” (IPP). If the cloud print service 321 holds the attributes for the media size, the cloud print service 321 returns values (A4, B5, Letter, etc.) associated with the attributes. If the attributes designated by “Get-print-Attributes” are not included in the queue for the cloud-print-support printer 104 on the cloud print service 321, the cloud print service 321 does not return any associated values as a response. The capability information acquired in step S803 is merely capability information about which the OS 313 inquires, regardless of the type and capabilities of the connected printer.

The OS 313 updates the device capability information using the capability information acquired from the cloud print service 321. In step 804, the OS 313 adds the capability information acquired in step S803 illustrated in FIG. 8A to the device capability information generated in step S3012 illustrated in FIG. 3B. If the device capability information is updated, the device capability information managed by the client terminal 101 can be updated by performing the processing in step S803. In the device capability information update processing in step S804, the device capability information only on the attribute values defined as the industry-standard specifications is updated.

Next, in step S805, the OS 313 issues a notification about an event and an application programming interface (API) used to edit the device capability information to the print setting extension application 312. This event notification timing is registered when the print setting extension application 312 is installed on the OS 313 of the client terminal 101.

Upon receiving this event, the print setting extension application 312 transmits a request for acquiring capability information to the cloud print service 321. In this capability information acquisition processing, capability information for writing setting items and attribute values uniquely defined by the printer vendor into the device capability information is acquired.

Upon receiving the event from the OS 313, in step S806, the print setting extension application 312 transmits an inquiry about capability information about the cloud-print-support printer 104 via the cloud print service 321. In this case, the print setting extension application 312 transmits an inquiry about capability information corresponding to the setting items unique to the printer vendor and the setting items including attribute values inherent in the printer vendor to the cloud print service 321. Like in step S802 illustrated in FIG. 8A, the inquiry is issued using “Get-print-Attributes” and the capability information is acquired by designating the item names of the setting items about which the print setting extension application 312 inquires as item names. The present exemplary embodiment is described on the premise that the capability information corresponding to setting items uniquely defined by the printer vendor and setting items including attribute values uniquely defined by the printer vendor is acquired in step S806. The capability information corresponding to setting items that are already acquired in the capability information acquisition processing by the OS 313 may also be acquired.

Upon receiving the inquiry about the unique capability information from the print setting extension application 312, in step S807, the cloud-print-support printer 104 transmits a response to the print setting extension application 312 via the cloud print service 321. The responding method used in this case is similar to that used in step S3011 illustrated in FIG. 3A described above. In the present exemplary embodiment, in step S807, the cloud print service 321 returns the capability information about the cloud-print-support printer 104 stored in the cloud print service 321. Upon receiving the request in step S806, the cloud print service 321 may acquire the capability information from the cloud-print-support printer 104 again to return the capability information to the client terminal 101.

The print setting extension application 312 that has acquired the capability information from the cloud-print-support printer 104 edits the device capability information managed by the OS 313 through a configuration information object. The configuration information object is a data set for editing the device capability information. The print setting extension application 312 cannot directly edit the device capability information included in the OS 313. For this reason, the print setting extension application 312 uses this configuration information object to change the device capability information included in the OS 313. In step S808, the capability information, such as “stapleless binding” and “storage of jobs in printer”, that are acquired in step S807 illustrated in FIG. 8A is converted into device capability information and the device capability information is added to the configuration information object to thereby edit the device capability information. After completion of the processing up to step S808, in addition to the capability information on the standard setting items acquired in the inquiry from the OS 313, the setting items and attribute values that are uniquely defined by the printer vendor are stored in the device capability information.

Next, in step S809, the print setting extension application 312 transmits the edited device capability information to the OS 313. The OS 313 stores the device capability information acquired from the print setting extension application 312 in association with the print queue.

When the OS 313 updates the device capability information, in step S810, an object used as a trigger to display the UI for the print setting extension application 312 is enabled. The object used as a trigger to display the UI for the print setting extension application 312 is, for example, an object 1104 illustrated in FIG. 11. Before the processing in step S810 is completed, the object 1104 is grayed out, so that the print setting screen for the print setting extension application 312 is not displayed even when the user clicks the object 1104. After the processing in step S810 is completed, the gray-out of the object 1104 is canceled so that the user can select the object 1104.

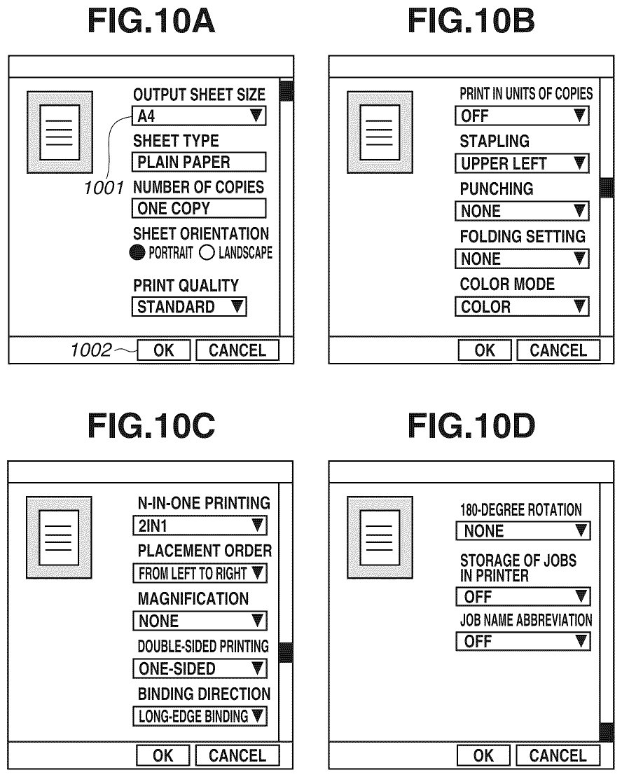

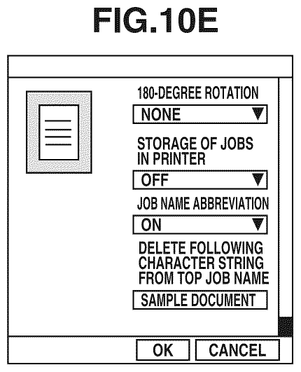

When the user selects the object 1104, in step S811, the print setting extension application 312 is started and a print setting screen as illustrated in FIGS. 10A to 10E is displayed. This print setting screen is independent of the type of the document generation application 315 to be used.

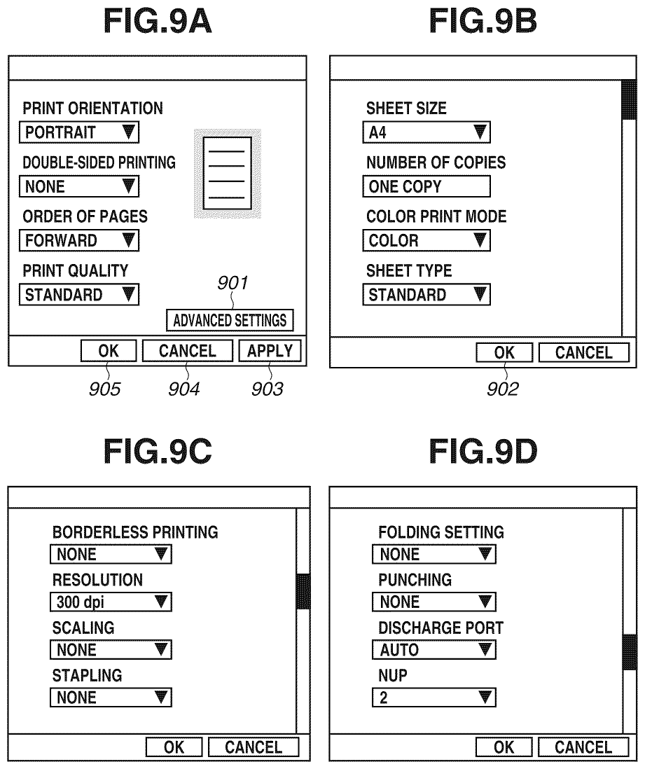

If the print setting extension application 312 is not associated with the selected print queue, a standard print setting screen pre-installed on the OS 313 as illustrated in FIG. 9A is displayed. On the standard print setting screen, an advanced settings button 901 is pressed to display an advanced print setting screen illustrated in FIG. 9B. Thus, an advanced print setting screen for setting the setting items that cannot be displayed on the standard print setting screen illustrated in FIG. 9A can be displayed. The advanced print setting screen illustrated in FIG. 9B can be scrolled by operating a scrollbar. As illustrated in FIGS. 9C and 9D, print settings can be made on a plurality of setting items supported by the OS 313. An OK button 902 is selected to store the current print settings and return to the screen illustrated in FIG. 9A. An apply button 903 illustrated in FIG. 9A is used to store the print settings. A cancel button 904 is used to return to the screen illustrated in FIG. 11 without storing the print settings. When an OK button 905 is selected, the print settings are stored and the screen returns to the screen illustrated in FIG. 11. The print setting items and attribute values that are uniquely defined by the printer vendor cannot be set on the screens illustrated in FIGS. 9A to 9D.

The print setting extension application 312 will be described in more detail. The print setting extension application 312 receives the print setting information generated based on the print setting capability information generated by the OS 313 based on the device capability information, and displays an extended print setting screen illustrated in FIG. 10A. The extended print setting screen can be scrolled by operating a scrollbar as illustrated in FIGS. 10A to 10E, allowing setting values for various print setting items to be set.

For example, an output sheet size indicated by a setting item 1001 in FIG. 10A is print setting information generated based on “psk:PageMediaSize” illustrated in FIG. 6B. Further, the print setting extension application 312 generates an “A4” as a choice for the output sheet size based on print setting information “psk:IOSA4” and displays the generated choice. Thus, the print setting extension application 312 converts the device capability information into setting values and displays the extended print setting screen. The extended print setting screen is generated based on the device capability information including capability information on the setting items unique to the printer vendor. This allows the setting items and setting values that cannot be set on the screens provided by the OS 313 as illustrated in FIGS. 9A to 9D to be set.

The user selects an object 1002 on the screen of FIG. 10A that is displayed by the print setting extension application 312. The object 1002 is an object for determining the print settings. The print setting extension application 312 provides a function that enables the user to change print settings, as appropriate. If the print settings are changed, the print setting extension application 312 stores the changed setting values. For example, suppose that the user has changed the media size from “A4” to “Letter” on the UI, the print setting information held in the print setting extension application 312 is changed from “A4” to “Letter”. When the object 1002 is selected, the print setting extension application 312 acquires the print setting information processed in control of the print setting screen from the print setting screen, and transmits the print setting information to the OS 313. After transmitting the print setting information to the OS 313, in step S812, the print setting extension application 312 closes the print setting screen illustrated in FIGS. 10A to 10E. After completion of the processing in step S812, the print setting screen illustrated in FIG. 11 is displayed. On the print setting screen displayed in this case, setting values are set by the print setting extension application 312.

When the user selects an object 1105 on the screen illustrated in FIG. 11, a print instruction is input to the OS 313. In step S813, the OS 313 performs printing processing based on the instruction input via the document generation application 315.

When the instruction to perform printing is issued, in step S814, the OS 313 generates intermediate data and transmits the generated intermediate data and the print setting information edited on the print setting screen to the print setting extension application 312. The intermediate data is data to be generated before being converted into print data, such as page-description language (PDL) data. The intermediate data is, for example, XML paper specification (XPS) data. The print setting information is also included in the intermediate data.

Upon receiving the intermediate data and the print setting information from the OS 313, in step S815, the print setting extension application 312 generates print data based on the intermediate data, and also generates print capability information based on the print setting information. The print data is, for example, PDL data, such as a portable document format (PDF) file. Specifically, the print capability information is information obtained by describing print setting information with attribute values defined by the IPP. After generating the print data, in step S816, the print setting extension application 312 transmits the generated print data and print capability information to the print queue on the OS 313.

Steps S814 to S816 are processing to be performed with the print setting extension application 312 associated with the print queue installed on the client terminal 101. With the print setting extension application 312 not installed on the client terminal 101, the client terminal 101 performs processing to be described below in step S816. In step S817, the OS 313 generates XPS data, edits a page layout, converts the XPS data into a predetermined format, and generates print data and print capability information. The predetermined format is, for example, a PDF or Printer Working Group (PWG)-Raster format.

In step S818, the OS 313 transmits the print data and print capability information transmitted from the print setting extension application 312, or the print data and print capability information generated by the OS 313 to the cloud print service 321 through the print queue.

In step S819, the cloud print service 321 transmits the print data and print capability information transmitted from the client terminal 101 to the cloud-print-support printer 104. In the present exemplary embodiment, upon receiving the print data and print capability information, the cloud print service 321 transmits the received print data and capability information to the cloud-print-support printer 104. The cloud-print-support printer 104 may periodically send an inquiry to the cloud print service 321 to acquire print data on which printing is not performed yet and print capability information corresponding to the print data.

The above-described configuration allows the print data in which the print settings made using the print setting extension application 312 are reflected to be transmitted to the cloud-print-support printer 104 via the cloud print service 321.

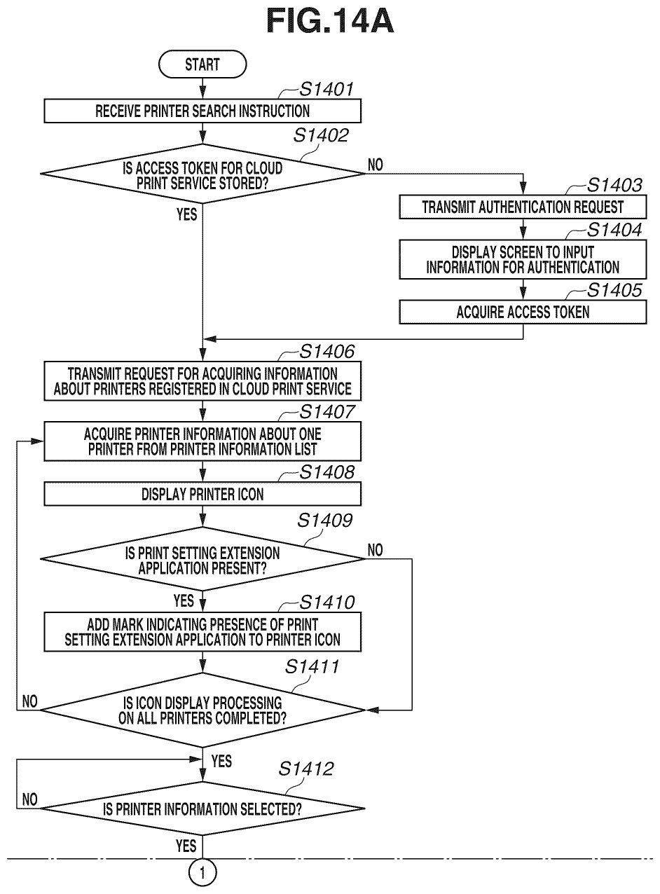

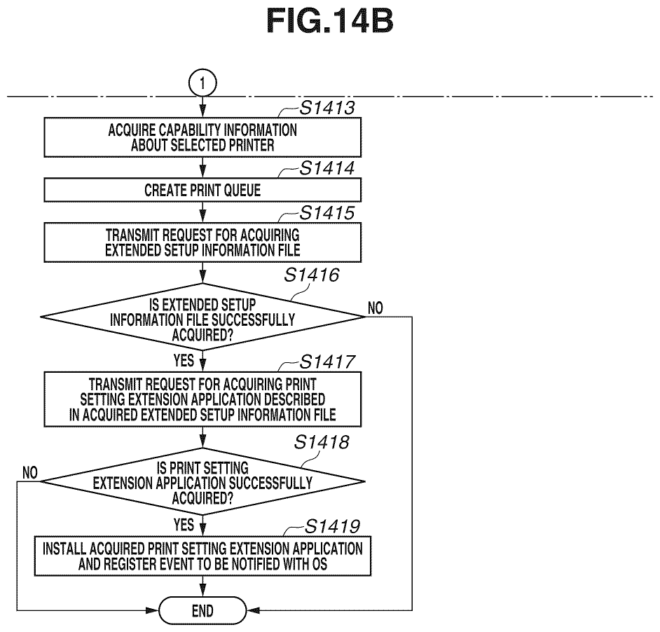

FIGS. 14A and 14B are a flowchart illustrating processing for the OS 313 to add a print queue to the client terminal 101 and install the print setting extension application 312. A program for performing the processing illustrated in this flowchart is stored in the storage unit 214 of the client terminal 101. The CPU 212 runs the program to thereby perform the processing.

In step S1401, the CPU 212 displays the screen illustrated in FIG. 12 and receives a printer search instruction. If the user selects the object 1201 illustrated in FIG. 12, the CPU 212 receives the printer search instruction.

In step S1402, the CPU 212 determines whether an access token for the cloud print service 321 is stored. The client terminal 101 stores the access token for acquiring information from the cloud print service 321 for each user that logs into the client terminal 101. The CPU 212 determines whether the access token associated with the user that has logged into the client terminal 101 is stored. If the access token is stored (YES in step S1402), the processing proceeds to step S1406 to be described below.

If the access token is not stored (NO in step S1402), the processing proceeds to step S1403. In step S1403, the CPU 212 transmits an authentication request to the cloud print service 321. Further, the CPU 212 receives a URL used to display a screen to input information for authentication from the cloud print service 321.

In step S1404, the CPU 212 accesses the received URL and displays the screen for inputting information for authentication. Examples of the information for authentication include a user ID and a password.

In step S1405, the CPU 212 transmits the input information for authentication to the cloud print service 321 and acquires the access token. If the authentication to the cloud print service 321 is unsuccessful, the CPU 212 cannot acquire the access token, and thus terminates the processing illustrated in FIG. 14A.

In step S1406, the CPU 212 transmits a request for acquiring printer information registered with the cloud print service 321 to the cloud print service 321 using the access token. The cloud print service 321 selects information about the printer that can be used by the user identified by the received access token, and transmits the selected information to the client terminal 101. In this case, the CPU 212 transmits a printer information list including the printer name registered in association with the printer that can be used by the user identified by the access token received from the client terminal 101, the HWID of the printer, and information indicating whether the print setting extension application 312 is present to the model of the printer.

The CPU 212 performs processing of displaying the printer information acquired from the cloud print service 321 on the display unit 216 of the client terminal 101. First, in step S1407, the CPU 212 acquires printer information about one printer from the acquired printer information list. Next, in step S1408, the CPU 212 displays the icon corresponding to the printer acquired in step S1407 on the display unit 216. In step S1409, the CPU 212 determines whether the print setting extension application 312 is present with reference to the printer information. If the print setting extension application 312 is present (YES in step S1409), the processing proceeds to step S1410. If the print setting extension application 312 is not present (NO in step S1410), the processing proceeds to step S1411. In step S1410, the CPU 212 adds a mark indicating that the print setting extension application is present to the printer icon. In step S1411, the CPU 212 determines whether the icon display processing on all printers in the printer information list acquired in step S1406 is completed. If the processing on all printers is completed (YES in step S1411), the processing proceeds to step S1412. If the processing on all printers is not completed (NO in step S1411), the processing returns to step S1407. The display processing in steps S1407 to S1410 is performed to thereby display the printer information list on the area 1202 illustrated in FIG. 12. Further, information indicating whether the print setting extension application 312 is present is displayed as an icon.

In step S1412, the CPU 212 determines whether printer information is selected. The CPU 212 repeatedly performs the processing in step S1412 until printer information is selected. If printer information is selected (YES in step S1412), the processing proceeds to step S1413.

In step S1413, the CPU 212 transmits a request for acquiring capability information about the selected printer to the cloud print service 321. In this case, an inquiry about the setting items preliminarily registered with the OS 313 is sent to the cloud print service 321.

In step S1414, the CPU 212 updates the printer capability information stored by the client terminal 101 based on the information acquired from the cloud print service 321, and creates a print queue.

In step S1415, the CPU 212 transmits a request for acquiring the extended setup information file to the online support service 351. This acquisition request includes the HWID of the printer.

In step S1416, the CPU 212 determines whether the acquisition of the extended setup information file is successful. If the acquisition of the extended setup information file is successful (YES in step S1416), the processing proceeds to step S1417. If the acquisition of the extended setup information file is unsuccessful (NO in step S1416), the CPU 212 terminates the processing illustrated in FIG. 14B.

In step S1417, the CPU 212 transmits a request for acquiring the print setting extension application 312 described in the acquired extended setup information file to the application management service 331. The CPU 212 acquires the application identifier for the print setting extension application 312 from the extended setup information file, designates the acquired application identifier, and transmits a request for acquiring the print setting extension application 312 to the application management service 331.

In step S1418, the CPU 212 determines whether the acquisition of the print setting extension application 312 is successful. If the acquisition of the print setting extension application 312 is unsuccessful (NO in step S1418), the CPU 212 terminates the processing illustrated in FIGS. 14A and 14B. If the acquisition of the print setting extension application 312 is successful (YES in step S1418), the processing proceeds to step S1419.

In step S1419, the CPU 212 installs the acquired print setting extension application 312 and registers the application identifier for the print setting extension application 312 in a state where the application identifier is associated with the print queue. Further, an event indicating a notification timing is registered with the OS 313. In this case, if the print queue associated with the print setting extension application 312 is selected on a print setting screen displayed by the document generation application 315, in step S1419, an event is registered to issue an event notification to the print setting extension application 312.

The above-described processing is processing up to the registration of the print setting extension application 312 in the client terminal 101.

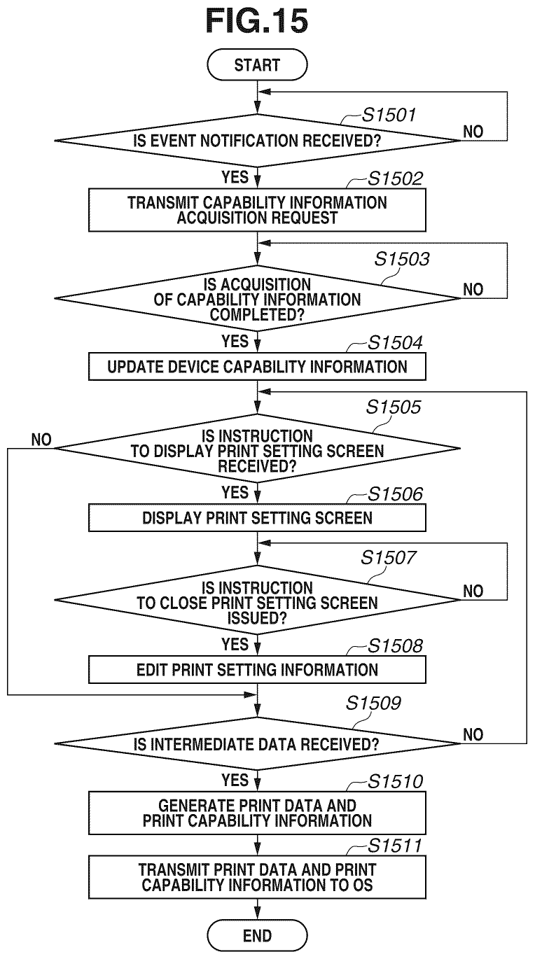

Next, processing of making print settings using the installed print setting extension application 312 and generating print data will be described with reference to FIG. 15. A program for performing the processing illustrated in FIG. 15 is stored in the print setting extension application 312, and the program is loaded into the memory 213 of the client terminal 101 and is run by the CPU 212.

In step S1501, the CPU 212 determines whether an event notification is received. The term “event” refers to an event issued by the OS 313 to issue a notification about the registration timing in step S1419 illustrated in FIG. 14B to the print setting extension application 312. If the event notification is not received (NO in step S1501), the CPU 212 repeatedly performs the processing in step S1501.

If the event notification is received (YES in step S1501), the processing proceeds to step S1502.

In step S1502, the CPU 212 transmits a request for acquiring capability information to the cloud print service 321. The CPU 212 transmits a request for acquiring capability information on the setting items set in the print setting extension application 312 to the cloud print service 321. In this case, capability information on other setting items that are not acquired in step S1406 illustrated in FIG. 14A is also acquired.

In step S1503, the CPU 212 determines whether the acquisition of capability information is completed. If the acquisition of capability information is not completed (NO in step S1503), the CPU 212 repeatedly performs the processing in step S1503. If the acquisition of capability information is completed (YES in step S1503), the processing proceeds to step S1504.

In step S1504, the CPU 212 updates the device capability information with the acquired capability information. When the processing in step S1504 is performed, the capability information on setting items that are not acquired by the OS 313 is also stored in the client terminal 101.

In step S1505, the CPU 212 determines whether a print setting screen display instruction issued by the print setting extension application 312 is received. The print setting screen display instruction issued by the print setting extension application 312 is, for example, an instruction issued based on a user operation, such as selection of the object 1104 illustrated in FIG. 11. If the print setting screen display instruction is not received (NO in step S1505), the processing proceeds to step S1509. If the print setting screen display instruction is received (YES in step S1505), the processing proceeds to step S1506.

In step S1506, the CPU 212 displays the print setting screen illustrated in FIGS. 10A to 10E based on the printer device information updated in step S1504. Further, the CPU 212 receives a user operation for selecting setting values via the displayed print setting screen.

In step S1507, the CPU 212 determines whether an instruction to close the print setting screen by the print setting extension application 312 is issued. If the instruction to close the print setting screen is not issued (NO in step S1507), the CPU 212 performs the processing in step S1507 again. If the instruction to close the print setting screen is issued (YES in step S1507), the processing proceeds to step S1508.

In step S1508, the CPU 212 edits print setting information with the setting values selected on the print setting screen displayed by the print setting extension application 312. Then, the CPU 212 closes the print setting screen displayed by the print setting extension application 312.

In step S1509, the CPU 212 determines whether the print setting extension application 312 has received intermediate data from the OS 313. If the intermediate data is not received (NO in step S1509), the processing returns to step S1505. If the intermediate data is received (YES in step S1509), the processing proceeds to step S1510.

In step S1510, the CPU 212 generates print data and print capability information based on the intermediate data received by the print setting extension application 312. The CPU 212 generates image data in a predetermined format based on the intermediate data and the print setting information. Further, the CPU 212 generates print capability information described with attribute values defined by the IPP based on the print setting information. In the print capability information, any information can be freely described in addition to attribute values defined by the IPP. Thus, setting items and attribute values that are uniquely defined by the printer vendor can also be described in the print capability information.

In step S1511, the CPU 212 provides the generated print data to the OS 313. The OS 313 transmits the data received through the print queue to the cloud print service 321.

The processing procedure to be performed when print settings are made using the print setting extension application 312 and print data and print capability information are generated has been described above.

The above-described processing makes it possible to set setting values for setting items unique to the printer vendor when the user selects a print queue associated with a general-purpose cloud printer driver or a local printer driver to transmit print data.

A second exemplary embodiment will now be described. In the first exemplary embodiment, in the case of registering the cloud-print-support printer 104 with the cloud print service 321, information indicating whether the supported print setting extension application 312 is present is stored, and in adding a print queue to the client terminal 101, information used to determine whether the print setting extension application 312 is present on the print queue is displayed using the above-described information. On the other hand, the vendor can register the print setting extension application 312 with the application management service 331 at any timing. Thus, the print setting extension application 312 can be registered with the application management service 331 after the cloud-print-support printer 104 is registered with the cloud print service 321. In this case, it may be desirable to update the information indicating whether the print setting extension application 312 is present.

The second exemplary embodiment illustrates a configuration example in which it can be determined whether the print setting extension application 312 is present in printer selection processing in adding a print queue to the client terminal 101 even when the print setting extension application 312 is registered with the application management service 331 after the cloud-print-support printer 104 is registered with the cloud print service 321.

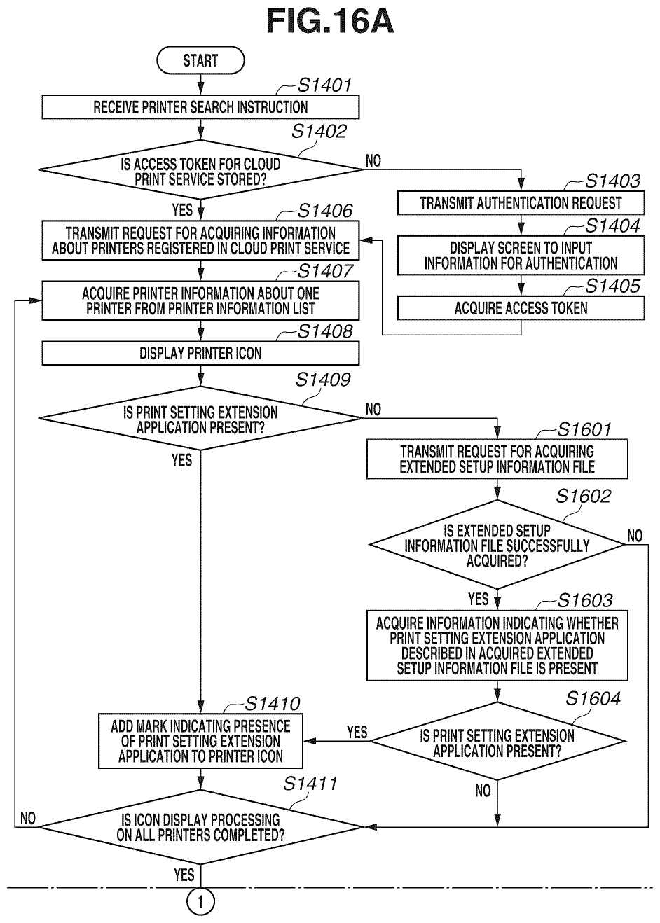

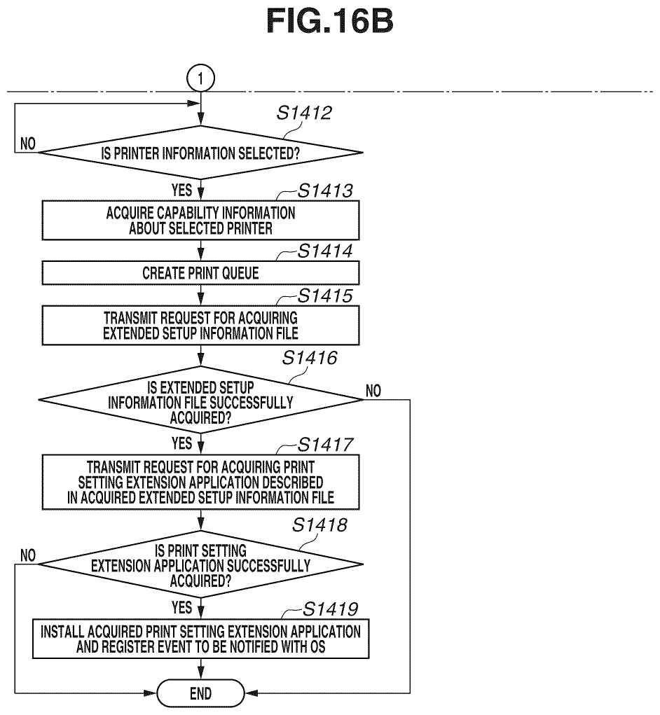

FIGS. 16A and 16B are a flowchart illustrating processing for the OS 313 to add a print queue to the client terminal 101 and install the print setting extension application 312 according to the present exemplary embodiment. Like in FIGS. 14A and 14B, a program for performing the processing in this flowchart is stored in the storage unit 214 of the client terminal 101. The CPU 212 runs the program to thereby perform the processing. Like numbers refer to like step processing in FIGS. 14A and 14B. The differences from the processing in FIGS. 14A and 14B will now be described.

In step S1409, the CPU 212 determines whether the print setting extension application 312 is present with reference to the printer information. If the print setting extension application 312 is present (YES in step S1409), the processing proceeds to step S1410. If the print setting extension application 312 is not present (NO in step S1409), the processing proceeds to step S1601. In step S1601, the CPU 212 transmits a request for acquiring the extended setup information file to the online support service 351. This acquisition request includes the HWID of the printer.

In step S1602, the CPU 212 determines whether the acquisition of the extended setup information file is successful. If the acquisition of the extended setup information file is successful (YES in step S1602), the processing proceeds to step S1603. If the acquisition of the extended setup information file is unsuccessful (NO in step S1602), the processing proceeds to step S1411.

In step S1603, the CPU 212 transmits a request for acquiring information indicating whether the print setting extension application 312 described in the acquired extended setup information file is present to the application management service 331. The CPU 212 acquires the application identifier for the print setting extension application 312 from the extended setup information file, designates the acquired application identifier, and transmits the request for acquiring information indicating whether the print setting extension application 312 is present to the application management service 331.

In step S1604, the CPU 212 determines whether the print setting extension application 312 is present.

If the print setting extension application 312 is present (YES in step S1604), the processing proceeds to step S1410.

If the print setting extension application 312 is not present (NO in step S1604), the processing proceeds to step S1411.

### Advantageous Effects of Second Exemplary Embodiment

The application of the processing procedure according to the second exemplary embodiment makes it possible to acquire information indicating whether the print setting extension application 312 is present each time a print queue is added to the client terminal 101 and to display information for the user to identify whether the print setting extension application 312 is present, even when the print setting extension application 312 is registered with the application management service 331 after the cloud-print-support printer 104 is registered with the cloud print service 321.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

In adding a print queue for a printer including a function intended by a user to a terminal, the user can check whether an application for extending the corresponding function is present in printer selection processing, thereby facilitating the user to add the intended print queue.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-174111, filed Oct. 31, 2022, which is hereby incorporated by reference herein in its entirety.

What is claimed is:

1. An information processing apparatus on which a printer driver is installed, the information processing apparatus comprising:
one or more processors; and
at least one memory in communication with the one or more processors and having stored thereon instructions, which when executed by the one or more processors, cause the information processing apparatus to function as:
a reception unit configured to receive printer information about a printer registered with a cloud print service from the cloud print service;
an acquisition unit configured to acquire information indicating whether an extension application is present from the printer information;
a display unit configured to display a printer list based on the information acquired by the acquisition unit;
a selection unit configured to select a printer from the printer list; and
an installation unit configured to install the printer driver and the extension application with the selected printer.

2. A system including a cloud print service comprising an information processing apparatus on which a printer driver is installed, the information processing apparatus includes:
one or more processors; and
at least one memory in communication with the one or more processors and having stored thereon instructions, which when executed by the one or more processors, cause the information processing apparatus to function as:
a reception unit configured to receive printer information about a printer registered with the cloud print service from the cloud print service;
an acquisition unit configured to acquire information indicating whether an extension application is present from the printer information;
a display unit configured to display a printer list based on the information acquired by the acquisition unit;
a selection unit configured to select a printer from the printer list; and
an installation unit configured to install the printer driver and the extension application with the selected printer;
a registration unit configured to register a printer;
a storage unit configured to acquire an extended setup information file for the registered printer and store the acquired extended setup information file together with printer information about the registered printer; and
a responding unit configured to return a response to an inquiry from the acquisition unit, the response indicating whether the extension application is present.

3. The system according to claim 2, wherein with the response indicating that the extension application is present to a specific printer returned by the responding unit, the display unit displays the printer list to identify the presence of the extension application to the specific printer.

4. The system according to claim 2, wherein in a case where the storage unit has not acquired the extended setup information file for the registered printer, the responding unit returns the response indicating that the extension application is not present.

5. The system according to claim 2, wherein with the response indicating that the extension application is not present to a specific printer returned by the responding unit, the display unit displays the printer list such that the presence of the extension application to the specific printer is unidentifiable.

6. A control method for a system including an information processing apparatus on which a printer driver is installed and a cloud print service, the control method comprising:
receiving printer information about a printer registered with the cloud print service from the cloud print service;
acquiring information indicating whether an extension application is present from the printer information;
displaying a printer list based on the acquired information;
selecting a printer from the printer list;
installing the printer driver and the extension application with the selected printer;
registering a printer;
acquiring an extended setup information file for the registered printer and storing the extended setup information file acquired together with the printer information about the registered printer; and
returning a response to an inquiry in the acquisition, the response indicating that the extension application is present.

7. The control method according to claim 6, wherein the printer list is displayed to identify the presence of the extension application to a specific printer with the response indicating that the extension application is present returned.

8. The control method according to claim 6, wherein in a case where the extended setup information file for a specific printer has not been acquired, the response indicating that the extension application is not present is returned.

9. The control method according to claim 6, wherein with the response indicating that the extension application is not present to a specific printer returned, the printer list is displayed such that the presence of the extension application to the specific printer is unidentifiable.

10. A non-transitory computer-readable storage medium storing a program that causes an information processing apparatus on which a printer driver is installed to execute processing comprising:
acquiring printer information about a printer registered with a cloud print service from the cloud print service;
acquiring information indicating whether an extension application is present from the printer information;
displaying a printer list based on the acquired information;
selecting a printer from the printer list; and
installing the printer driver and the extension application with the selected printer.
